(19) United States
(12) Patent Application Publication
(10) Pub. No.: US 2011/0182063 A1
(43) Pub. Date: Jul. 28, 2011

(54) Table Lamp

(75) Inventor: Duan-Cheng Hsieh, Taipei City (TW)

(73) Assignee: HABITEX CORPORATION, Taipei City (TW)

(21) Appl. No.: 12/694,147

(22) Filed: Jan. 26, 2010

(51) Int. Cl. F21V 19/02

(52) U.S. Cl. 362/220

(57) ABSTRACT

A table lamp includes a supporting rod connected pivotally to a base and rotatable relative to the base about a pivot axis. A pivot unit includes a first pivot seat connected to the supporting rod, and a second pivot seat connected pivotally to the first pivot seat, rotatable relative to the first pivot seat, and formed with a through hole with a hole axis. A lamp unit includes a tubular lamp-mounting body mounted with a lamp, extending through the through hole, rotatable relative to the second pivot seat about the hole axis, and movable relative to the second pivot seat along the hole axis.

### BACKGROUND OF THE INVENTION

1. Field of the Invention

The invention relates to a table device, more particularly to a table lamp that is easily adjusted to a desired position.

2. Description of the Related Art

A conventional table lamp usually includes a bellows tube interconnecting a base and a lamp unit and adjustable to support the lamp unit in a position relative to the base. However, adjustment of the bellows tube is limited such that the conventional table lamp may not be adjusted to a desired position.

### SUMMARY OF THE INVENTION

Therefore, an object of the present invention is to provide a table lamp device that is easily adjusted to a desired position.

According to the present invention, a table lamp comprises:

a base;

a supporting rod having a first end connected pivotally to the base such that the supporting rod is rotatable relative to the base about a first axis, and a second end opposite to the first end;

a pivot unit including
a first pivot seat connected to the second end of the supporting rod, and
a second pivot seat connected pivotally to the first pivot seat such that the second pivot seat is rotatable relative to the first pivot seat, and formed with a through hole that has a hole axis; and

a lamp unit including
a tubular lamp-mounting body that extends through the through hole in the second pivot seat such that the lamp-mounting body is rotatable relative to the second pivot seat about the hole axis and that the lamp-mounting body is movable relative to said second pivot seat along the hole axis, and
a lamp mounted to the lamp-mounting body.

### BRIEF DESCRIPTION OF THE DRAWINGS

Other features and advantages of the present invention will become apparent in the following detailed description of the preferred embodiments with reference to the accompanying drawings, of which:

FIG. 1 is a schematic view showing the first preferred embodiment of a table lamp device according to the present invention;

FIG. 2 is a fragmentary, partly schematic sectional view showing a lamp unit, a pivot unit and a supporting rod of the first preferred embodiment;

FIG. 3 is a fragmentary schematic side view showing the first preferred embodiment;

FIG. 4 is a schematic view of the first preferred embodiment illustrating rotation of a second pivot seat relative to a first pivot seat about a second axis;

FIG. 5 is a schematic view of the first preferred embodiment illustrating movement of the lamp unit relative to the second pivot seat; and

FIG. 6 is a fragmentary, partly schematic sectional view showing the second preferred embodiment of a table lamp according to the present invention.

### DETAILED DESCRIPTION OF THE PREFERRED EMBODIMENTS

Before the present invention is described in greater detail, it should be noted that like elements are denoted by the same reference numerals throughout the disclosure.

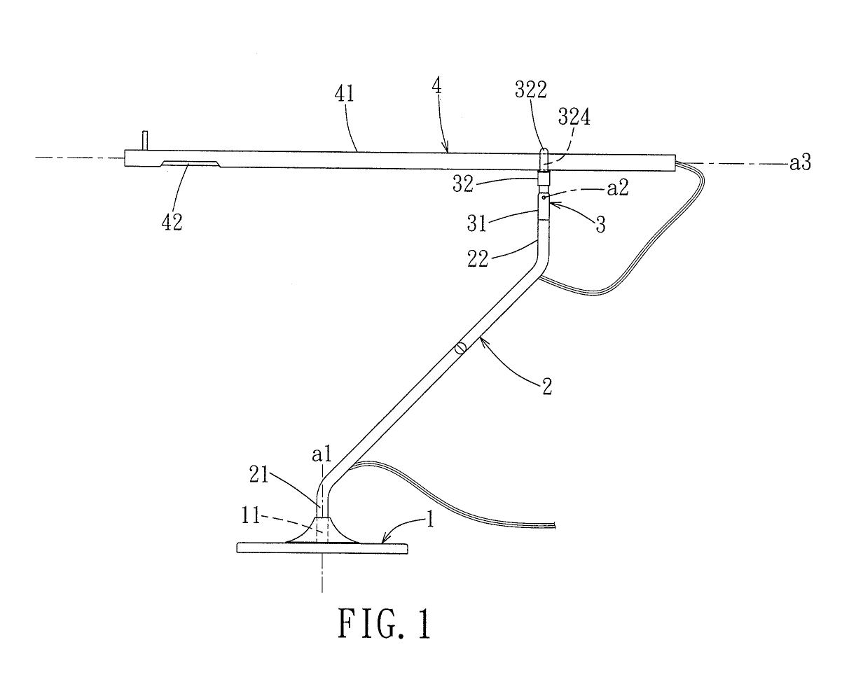

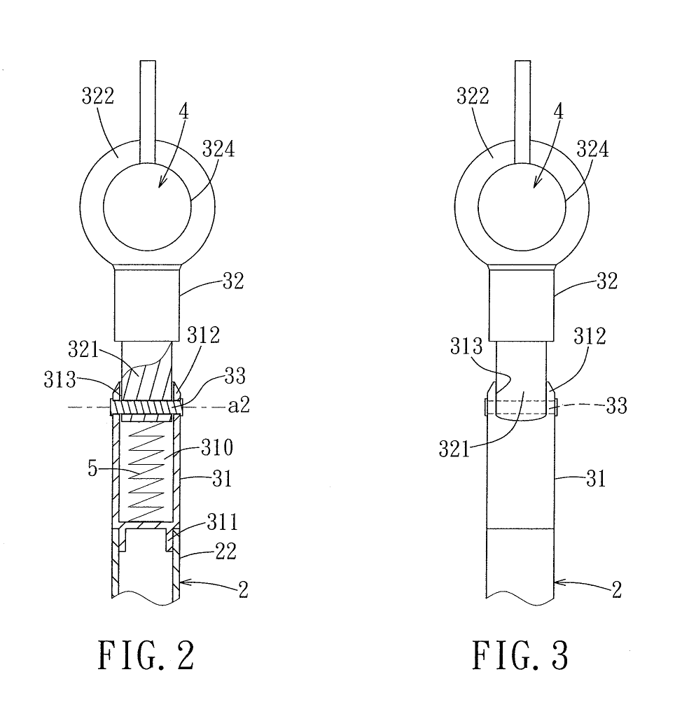

Referring to FIGS. 1 and 2, the first preferred embodiment of a table lamp according to the present invention is shown to include a base 1, a supporting rod 2, a pivot unit 3, and a lamp unit 4.

In this embodiment, the base 1 has a disc body, and a central protrusion projecting upwardly from the disc body and formed with an insertion hole 11 that extends along a first pivot axis (a1) that is parallel to a vertical direction.

The supporting rod 2 has a first end 21, and a second end 22 opposite to the first end 21. The first end 21 of the supporting rod 2 is inserted into the insertion hole 11 in the base 1 and is connected pivotally to the base 1 such that the supporting rod 2 is rotatable relative to the base 1 about the first pivot axis (a1).

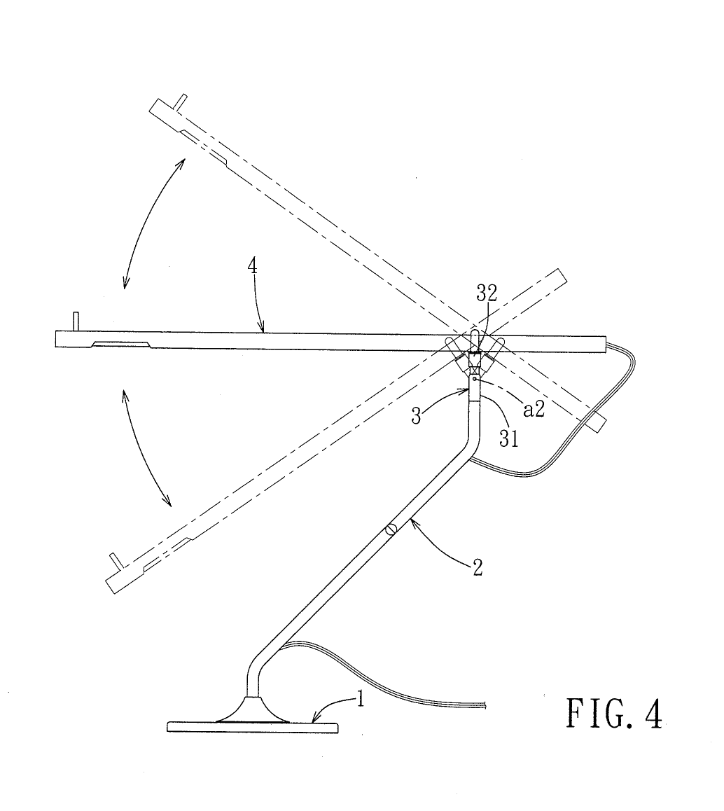

The pivot unit 3 includes a first pivot seat 31 and a second pivot seat 32. The first pivot seat 31 is connected to the second end 22 of the supporting rod 2. In this embodiment, referring further to FIG. 3, the first pivot seat 31 is configured with an inner receiving space 310, and has a lower end 311 inserted into and fixed to the second end 22 of the supporting rod 2, and an upper end 312 formed with a pivot groove 313 in spatial communication with the inner receiving space 310. In this embodiment, the pivot groove 313 has two open ends opposite to each other in a transverse direction transverse to the first pivot axis (a1). The second pivot seat 32 has a pivot end 321 and a mounting end 322 opposite to the pivot end 321. In this embodiment, the pivot end 321 of the second pivot seat 32 is disposed in the pivot groove 313 in the upper end 312 of the first pivot seat 31, and is coupled pivotally to the upper end 312 of the first pivot seat 31 by means of a connecting post 33 extending along a second pivot axis (a2), which is transverse to the first pivot axis (a1) and the transverse direction, through the upper end 312 of the first pivot seat 31 and the pivot end 321 of the second pivot seat 32 such that the second pivot seat 32 is rotatable relative to the first pivot seat 31 about the second pivot axis (a2), as shown in FIG. 4. The mounting end 322 of the second pivot seat 32 is formed with a through hole 324 that has a hole axis (a3) transverse to the second pivot axes (a2).

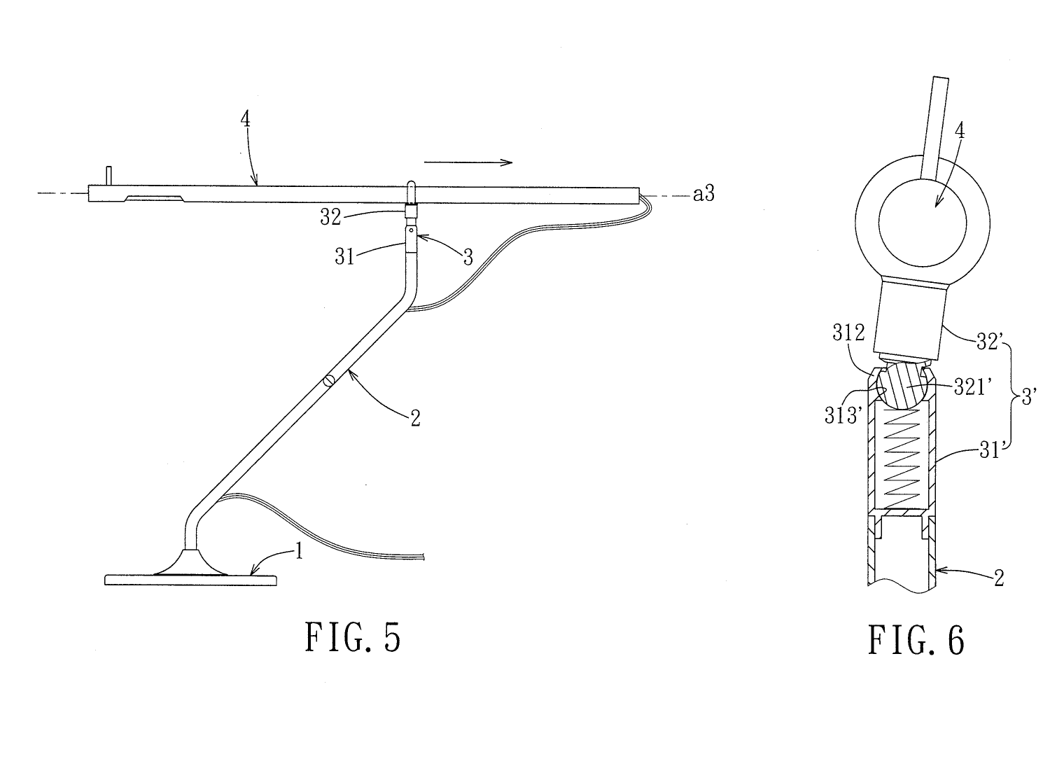

The lamp unit 4 includes a tubular lamp-mounting body 41, and a lamp 42 mounted to the lamp-mounting body 41. The lamp-mounting body 41 extends through the through hole 324 in the mounting end 322 of the second pivot seat 32 such that the lamp-mounting body 41 is rotatable relative to the second pivot seat 32 about the hole axis (a3) and that the lamp-mounting body 41 is movable relative to the second pivot seat 32 along the hole axis (a3), as shown in FIG. 5. In this embodiment, the lamp 42 includes a set of LEDs (not shown) and is disposed distal from the mounting end 322 of the second pivot seat 32. In other embodiments, the lamp 42 can include a light tube or a light bulb.

The table lamp further includes a resilient member 5, such as a compression spring, disposed in the inner receiving space 310 in the first pivot seat 31, and abutting against and in friction contact with the pivot end 321 of the second pivot seat 32 to thereby maintain the second pivot seat 32 at a desired position relative to the first pivot seat 31.

FIG. 6 illustrates the second preferred embodiment of a table lamp according to this invention, which is a modification of the first preferred embodiment. In this embodiment, for the pivot unit 3′, the pivot groove 313′ in the upper end 312 of the first pivot seat 31′ is in the form of a ball groove, and the pivot end 321′ of the second pivot seat 32 is in the form of a ball body that is received fittingly and rotatable within the ball groove such that the ball groove and the ball body constitute a universal joint.

In such a configuration, the table lamp of the present invention can be easily adjusted through rotation of the supporting rod 2, the second pivot seat 32, 32′ of the pivot unit 3, 3′ and the lamp-mounting body 41 of the lamp unit 4, and movement of the lamp-mounting body 41 of the lamp unit 4 so as to position the lamp 42 at a desired position within a relatively large range.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A table lamp comprising:
a base;
a supporting rod having a first end connected pivotally to said base such that said supporting rod is rotatable relative to said base about a first pivot axis, and a second end opposite to said first end;
a pivot unit including
a first pivot seat connected to said second end of said supporting rod, and
a second pivot seat connected pivotally to said first pivot seat such that said second pivot seat is rotatable relative to said first pivot seat, and formed with a through hole that has a hole axis; and
a lamp unit including
a tubular lamp-mounting body that extends through the through hole in said second pivot seat such that said lamp-mounting body is rotatable relative to said second pivot seat about the hole axis and that said lamp-mounting body is movable relative to said second pivot seat along the hole axis, and
a lamp mounted to said lamp-mounting body.

2. The table lamp as claimed in claim 1, wherein said base is formed with an insertion hole extending along the first pivot axis and permitting insertion of said first end of said supporting rod thereinto.

3. The table lamp as claimed in claim 1, wherein:
said first pivot seat of said pivot unit is configured with an inner receiving space, and has a lower end connected to said second end of said supporting rod, and an upper end formed with a pivot groove in spatial communication with said inner receiving space; and
said second pivot seat of said pivot unit has a pivot end disposed in said pivot groove in said upper end of said first pivot seat and coupled rotatably to said upper end of said first pivot seat, and a mounting end opposite to said pivot end and formed with said through hole;
said table lamp further comprising a resilient member disposed in said inner receiving space in said first pivot seat, and abutting against and in friction contact with said pivot end of said second pivot seat to thereby maintain said second pivot seat at a desired position relative to said first pivot seat.

4. The table lamp as claimed in claim 3, wherein:
said pivot groove in said upper end of said first pivot seat has two open ends opposite to each other in a direction transverse to the first pivot axis; and
said pivot unit further includes a connecting post extending along a second pivot axis transverse to the first pivot axis and the hole axis through said upper end of said first pivot seat and said pivot end of said second pivot seat such that said second pivot seat is rotatable relative to said first pivot seat about the second pivot axis.

5. The table lamp as claimed in claim 3, wherein said pivot groove in said upper end of said first pivot seat is in the form of a ball groove, and said pivot end of said second pivot seat is in the form of a ball body that is received fittingly and rotatably within said ball groove such that said ball groove and said ball body constitute a universal joint.
